(19) United States
(12) Patent Application Publication
(10) Pub. No.: US 2022/0393400 A1
(43) Pub. Date: Dec. 8, 2022

(54) MULTI-WAY CONNECTOR, ASSEMBLY CONNECTION AND METHOD AND DEVICE FOR PRODUCING A MULTI-WAY CONNECTOR

(71) Applicant: Rosenberger Hochfrequenztechnik GmbH & Co. KG, Fridolfing (DE)

(72) Inventors: Christian DANDL, Fridolfing (DE); Andreas GRUBER, Ainring (DE)

(21) Appl. No.: 17/775,910

(22) PCT Filed: Nov. 11, 2020
(86) PCT No.: PCT/EP2020/081761

§ 371 Date: May 11, 2022

(30) Foreign Application Priority Data
Nov. 14, 2019 (DE) 10 2019 130 774.0

(51) Int. Cl. H01R 13/639; H01R 13/504; H01R 43/18; H01R 43/02

(52) U.S. Cl. CPC H01R 13/639; H01R 13/504; H01R 43/18; H01R 43/02

(57) ABSTRACT

The invention relates to a multi-way connector (4) for electrically contacting electrical assemblies (2, 3). The multi-way connector (4) comprises a connector body (5) having a first connection surface (6) and having a second connection surface (7). The multi-way connector (1) also comprises a plurality of electrical contact elements (8), which extend through the connector body (5) at least from the first connection surface (6) to the second connection surface (7). The contact elements (8) form contact sections (9) in the region of the connection surfaces (6, 7) for electrically contacting corresponding counter contact elements (10) of the respective associated assembly (2, 3). The contact sections (9) on at least one of the connection surfaces (6, 7) can be mechanically secured to the respective associated counter contact elements (10). According to the invention, the connector body (5) has multiple foil elements (11) that are stacked on one another and connected to one another. A respective two of the foil elements (11) form a foil pair (12). At least one of the contact elements (8) runs between the two stacked foil elements (11) of at least one of the foil pairs (12).

The invention relates to a multi-way connector for electrically contacting electrical assemblies, having a connector body and a plurality of electrical contact elements, according to the preamble of claim 1.

The invention further relates to an assembly connection, having a first electrical assembly, a second electrical assembly, and a multi-way connector for electrically contacting the assemblies.

The invention additionally relates to a method and a device for producing a multi-way connector which is designed for electrically contacting electrical assemblies.

Multi-way connectors are known for the electrical contacting of electrical assemblies, in particular for providing an electrical connection between various electrical assemblies. The multi-way connectors generally establish a large number of individual connections for transmitting different electrical data and/or supply signals between the assemblies. It is not uncommon for several hundred independent individual connections to be required between the assemblies, for example between two electrical printed circuit boards (“PCBs”) or a printed circuit board and an integrated circuit (“IC”).

Multi-way connectors are also used for backplane applications, for example to electrically connect a main circuit board having one or more plug-in slots to a plug-in assembly in that the multi-way connector forms the plug connection between the main circuit board and the plug-in assembly.

The increasing miniaturization and expansion of the functional range of electrical assemblies, for example integrated circuits, requires an ever-closer arrangement of the contact elements of a multi-way connector.

One requirement for multi-way connectors is therefore to provide a high number of contact elements with a small pitch. At the same time, it is sometimes necessary to produce multi-way connectors in large quantities and thus as economically as possible as part of a mass production process.

In practice, for example, to produce a multi-way connector, a plastic plate is first provided with a plurality of vertical feedthroughs adjacent to one another, into each of which individual contact elements are inserted and fastened in separate operations in a further complex manufacturing step.

An exemplary, generic multi-way connector is described in US 2003/0008535 A1. For the production of the multi-way connector, US 2003/0008535 A1 proposes to first produce individual contact elements by a metal powder injection molding process and then to attach them in sufficiently large number to a connector body or to a plastic plate of the multi-way connector on both sides and to electrically connect the opposing contact elements to each other by separate throughplatings in the connector body.

This production process requires a comparatively large number of separate steps and is economically unsuitable for producing a multi-way connector with many hundreds of individual contacts, especially for mass production of the multi-way connector. Furthermore, the minimum achievable pitch of this production process is severely limited.

In view of the known prior art, the object of the present invention is to provide a multi-way connector which, in particular, provides a large number of individual connections with a narrow pitch and can preferably be produced inexpensively and reliably.

The present invention is also based on the task of providing an assembly connection with a multi-way connector which, in particular, provides a large number of individual connections with a small pitch and can preferably be produced cost-effectively and reliably.

Lastly, it is also the object of the invention to provide a method for producing a multi-way connector which can preferably be carried out cost-effectively and with high process reliability, in particular to provide a multi-way connector with a plurality of individual connections with a small pitch.

It is also an object of the invention to provide an advantageous device for a method for producing a multi-way connector.

The object is achieved for the multi-way connector having the features listed in claim 1. With regard to the assembly connection, the object is achieved by the features of claim 21. With respect to the method for producing the multi-way connector, the object is achieved by the features of claim 22 and with respect to the device by claim 29.

The dependent claims and the features described hereinafter relate to advantageous embodiments and variants of the invention.

A multi-way connector is provided for electrical contacting between electrical assemblies. The multi-way connector can be provided here in particular to provide an electrical connection between the electrical assemblies.

Preferably, the multi-way connector is provided for electrically contacting, in particular for connecting, exactly two electrical assemblies; in principle, however, it is also possible for the multi-way connector to contact and/or connect more than two electrical assemblies, for example three electrical assemblies, four electrical assemblies, five electrical assemblies, six electrical assemblies or even more electrical assemblies. Where exactly two assemblies are referred to in the following, this is not to be understood in a restrictive manner but is merely intended to provide a better understanding.

The multi-way connector can be designed to establish a plurality of, preferably independent, individual electrical connections between the assemblies. For example, the multi-way connector can be designed to enable different data connections in each case with one or more data channels and/or to enable different supply signals for transmitting different electrical currents at different voltages between the assemblies.

An electrical assembly can basically be any electrical assembly. For example, one of the assemblies or both assemblies can be an electrical circuit board, preferably equipped with one or more electrical components. It is also possible for one of the assemblies or for both assemblies to be any active or passive circuit, in particular an active or passive electrical circuit arranged in a circuit housing, for example a module of a base station of a mobile radio system or an antenna module/an antenna. For example, one of the assemblies or both assemblies can also be an integrated circuit, preferably a semiconductor chip in a chip housing. In the context of the invention, one of the electrical assemblies or both assemblies can even be an electrical cable or an electrical plug connector.

In particular, the assemblies to be electrically connected to each other can also be designed differently.

For example, to implement a backplane application, a first electrical assembly can be designed as a main circuit board with one or more plug-in slots and a second electrical assembly can be designed as a plug-in assembly for the main circuit board, wherein the electrical connection between an electrical circuit of the plug-in assembly and the main circuit board can be produced via the plug-in slot of the main circuit board by means of the multi-way connector according to the invention. A backplane application is a particularly preferred field of application of the invention.

However, it can also be provided, for example, that the first electrical assembly is in the form of a semiconductor chip and the second electrical assembly is in the form of a printed circuit board, wherein the multi-way connector according to the invention can be used to establish the electrical connection between the terminals of the chip housing and the printed circuit board.

According to a further example, it can be provided that the multi-way connector is used to establish an electrical connection between one or more semiconductor chips and a device for testing the one or more semiconductor chips.

In principle, the possible uses of the multi-way connector described below are numerous. The invention is not limited to one of the uses mentioned.

In accordance with the invention, the multi-way connector has a connector body with a first connection face and with a second connection face.

Each connection face can be used for electrical contacting or for establishing the electrical connection. The connection face is preferably flat. However, the connection face can also be stepped if necessary.

The connection faces preferably face the corresponding associated assembly when the multi-way connector is electrically connected to the assembly or assemblies. The connection faces are particularly preferably oriented parallel to a corresponding connection face of the associated assembly when the multi-way connector is electrically connected to the assembly or assemblies.

If the multi-way connector is intended for contacting more than two assemblies, the number of connection faces can be increased accordingly. For example, a third connection face, a fourth connection face, a fifth connection face, a sixth connection face or even more connection faces can be provided. Preferably, the number of connection faces corresponds to the number of assemblies to be contacted (for example, to be connected to one another), wherein in principle a plurality of assemblies, for example two assemblies, can also be contacted by the multi-way connector via a common connection face.

In accordance with the invention, the multi-way connector additionally has a plurality of electrical contact elements which extend through the connector body at least from the first connection face to the second connection face. The contact elements each form contact portions in the region of the connection faces for electrically contacting corresponding mating contact elements of the associated assembly.

A contact element according to the invention can in principle have any dimension. For example, however, the contact element can have a thickness of 1.0 mm or less, preferably 0.5 mm or less, particularly preferably 0.3 mm or less, very particularly preferably 0.2 mm or less, for example also 0.1 mm or less.

Preferably, the contact elements are oriented orthogonally to the connection faces.

The contact elements can extend along the shortest possible path from the first connection face to the second connection face.

It can be provided that all contact elements run parallel to each other. Depending on the particular application, however, the contact elements can also be arranged at an angle to each other.

Preferably, the contact elements are each arranged in the particular connection face in accordance with a pitch that corresponds to the pitch of the corresponding mating contact elements of the associated assembly.

In principle, the multi-way connector can have any number of contact elements, for example also only two contact elements. Preferably, however, more than two contact elements are used, for example three, four, five, six, seven, eight, nine, ten, twenty, thirty, forty, fifty, sixty, seventy, eighty, ninety, one hundred, two hundred, three hundred, four hundred, five hundred, a thousand or even more contact elements. The multi-way connector according to the invention is particularly suitable for use with a large number of contact elements.

In accordance with the invention, it is provided that the contact portions can each be mechanically fastened to the associated mating contact elements on at least one of the connection faces.

In particular, it can also be provided that the contact portions can be mechanically fastened to the associated mating contact elements on both or all connection faces. Preferably, half of the contact elements, the majority of the contact elements or all of the contact elements can be mechanically fastened to the mating contact elements associated with them.

The contact elements can be fastened to the mating contact elements by frictional engagement, interlocking engagement and/or integrally bonded engagement.

Preferably, the contact elements or the contact portions are designed to form a frictionally engaged connection with one of the mating contact elements of the associated assembly in the manner of a plug connection. Preferably, the contact elements or the contact portions are designed to form an interlocking connection with one of the mating contact elements of the associated assembly in the manner of a plug connection. The connection between a particular contact element and a mating contact element is preferably a plug connection.

It can be provided that the multi-way connector has contact elements of different construction, for example with different thicknesses, elasticity properties and/or characteristics of the contact portions and elastic portions.

The contact elements are preferably made in one piece but can also be made in a number of pieces if necessary.

In accordance with the invention, it is further provided that the connector body has a plurality of film elements stacked on top of the other and connected to one another. In each case at least two of the film elements form a film pair, wherein at least one of the contact elements runs between the two film elements stacked one on top of the other of at least one of the film pairs.

A film element in the context of the invention is in particular a film, for example a plastic sheet, with two opposing main faces and—compared to the main faces—very thin side faces. Preferably, the film element is a film according to conventional linguistic usage.

Preferably, the film elements are electrically non-conductive, particularly preferably made of a plastic. The film elements can, for example, be made of polyethylene or polypropylene or another plastic. If necessary, thermosets can also be provided for forming the film elements. Furthermore, elastomers can also be provided for forming the film elements, in particular if the subsequent connector body is additionally fixed or mechanically stabilized.

A film element can also be a ceramic film or a flat ceramic layer. The ceramic film can optionally be coated on one or both sides with a plastic layer and/or a metal layer. By using a ceramic film, the mechanical stability of the connector body can be improved. Further, the electrical properties of the ceramic can be advantageously used in the connector body, if applicable.

In principle, a film element can also be a composite film consisting of a plurality of individual film layers. For example, a metal-coated plastic film element can be advantageous to provide a shielding of the multi-way connector. The use of a metal coating can, for example, provide shielding between contact elements of different height levels or rows and/or shielding of the multi-way connector from adjacent electrical components and thus, in particular, improve the electromagnetic compatibility (EMC) of the multi-way connector.

Shielding can also be provided, for example, by inserting metal sheet webs between individual film elements or between film pairs of film elements.

A film element according to the invention can in principle have any geometry. For example, however, the film element can have a thickness of 5 mm or less, preferably 1 mm or less, particularly preferably 0.5 mm or less, very particularly preferably 0.4 mm or less, for example also 0.1 mm or even less.

It can be provided that film elements with different thicknesses are used to increase flexibility in the design of the connector body and the desired pitch. Preferably, however, the thicknesses of the film elements, in particular of all film elements that form film pairs with each other, are identical.

In principle, the connector body can have any number of film elements stacked on top of each other, for example even just two film elements. Preferably, however, more than two film elements are used, for example, three, four, five, six, seven, eight, nine, ten, twenty, thirty, forty, fifty, sixty, seventy, eighty, ninety, one hundred, two hundred, three hundred, four hundred, five hundred, one thousand or even more film elements.

Within the scope of the invention, it can also be provided that individual film elements with their main faces adjacent to each other or stacked on top of each other do not form a film pair, or that no contact element is arranged between film elements connected to each other. This can increase the flexibility in the geometric design of the connector body and the desired pitch.

It can be provided that film elements form exactly one film pair with an adjacent film element or form two film pairs with two adjacent film elements. For example, three film elements can form two film pairs with each other in that the outer two film elements each form a film pair with the middle film element.

In principle, any number of film pairs can be provided, for example, even only one film pair. Preferably, however, a plurality of film pairs are provided, for example two, three, four, five, six, seven, eight, nine, ten, twenty, thirty, forty, fifty, sixty, seventy, eighty, ninety, one hundred, two hundred, three hundred, four hundred, five hundred, a thousand or even more film pairs.

In addition to the film elements stacked on top of each other and the contact elements arranged between the film pairs, the connector body can also have further components, for example further films (for example also the intermediate film structure still mentioned below) or further contact elements which do not necessarily correspond to the structure or composition mentioned above. In a particularly preferred variant of the invention, however, the connector body consists exclusively of the stacked film elements and the contact elements arranged therebetween (but possibly still with a corresponding adhesive layer between the film elements).

In accordance with the invention, a three-dimensional multi-way connector or a three-dimensional connector body with preferably a plurality of contact elements can be realized by layering the individual film elements in an advantageous manner. The layering principle according to the invention makes it possible to insert the contact elements into the connector body in a closely spaced manner or with a very small pitch at low cost. At the same time, a multi-way connector of particularly high quality can be provided in accordance with the invention.

In an advantageous further development of the invention, it can be provided that the film pair for each of the contact elements forms a corresponding channel, through which the contact element extends between the connection faces.

Preferably, the contact elements run through the corresponding channels in such a way that the particular film pair does not form a curvature by receiving the contact element. In principle, however, a curvature can also be provided. If necessary, the curvature can be leveled by further film layers.

According to a further development of the invention, it can be provided that the channels are formed by impressions of the contact elements in at least one of the film elements of the film pair and/or by grooves in at least one of the film elements of the film pair and/or by recesses in an intermediate film structure arranged between the film elements of the film pair.

Preferably, the channels are pressed in between the film elements forming a film pair, thus allowing the contact elements to press into the film material. The resulting negative of the contact element can, lastly, form the channel. The film elements can be formed in such a way that sufficient material displacement is possible without any appreciable curvature occurring as a result of the contact elements being pressed in.

However, the channels can also be formed by the aforementioned grooves or recesses.

The groove can preferably be formed in only one of the film elements of a particular film pair. However, the groove can also be formed in both film elements of a particular film pair.

The intermediate film structure can have a plurality of film segments which are preferably placed in a suitable grid or in a suitable arrangement on at least one of the film elements forming a film pair, in such a way that the film-segment-free regions or the gaps between the film segments form the channels for the contact elements.

The film segments of the intermediate film structure can initially be connected to each other via connecting webs, which can facilitate application to a film element during production. The connecting webs can be removed later if necessary. However, the intermediate film structure can also be formed from a plurality of individually present film segments.

The intermediate film structure or its film segments can be stamped out from a film (as defined above).

The intermediate film structure or its film segments can be made of the same material as the film elements, but this is not absolutely necessary. Properties and designs of the film elements mentioned above and below can also be advantageously provided for the intermediate film structure, provided this is not technically impossible.

Preferably, the intermediate film structure is also electrically non-conductive, particularly preferably made of a plastic. The intermediate film structure can, for example, be formed from polyethylene or polypropylene or from another plastic. If necessary, thermosets can also be provided for forming the intermediate film structure. Furthermore, elastomers can also be provided for forming the intermediate film structure, in particular if the subsequent connector body is additionally fixed or mechanically stabilized.

In principle, the intermediate film structure can also be a composite film consisting of a plurality of individual film layers, in particular plastic layers, metal layers, ceramic layers and/or carbon fiber layers. For example, the intermediate film structure can be formed from a ceramic fiber composite. For example, a metal-coated plastic or ceramic film segment can also be advantageous to provide a shielding of the multi-way connector. By using a metal coating, for example, shielding can be provided between contact elements of different height levels or rows and/or shielding of the multi-way connector from adjacent electrical components can be provided and thus, in particular, the electromagnetic compatibility (EMC) of the multi-way connector can be improved.

In principle, the intermediate film structure can have any geometry. For example, however, the intermediate film structure can have a thickness of 5 mm or less, preferably 1 mm or less, particularly preferably 0.5 mm or less, very particularly preferably 0.4 mm or less, for example also 0.1 mm or even less. Preferably, the thickness of the intermediate film structure corresponds exactly or at least approximately to the thickness of the contact element which is inserted into the channel formed with the intermediate film structure.

It can be provided that intermediate film structures with different thicknesses are used to increase flexibility in the design of the connector body and the desired pitch. Preferably, however, the thicknesses of the intermediate film structures, in particular of all intermediate film structures provided in different height positions of the connector body, are identical.

In a preferred further development of the invention, it can be provided that the first connection face and the second connection face are arranged on different sides of the connector body.

In principle, however, it can also be provided that the connection faces are arranged on the same side of the connector body. The corresponding side face can then be divided into a plurality of regions that form the connection faces, for example the first connection face and the second connection face.

An embodiment of the connector body, according to which a plurality of connection faces are arranged on a common first side and at least one further connection face is arranged on a second side different from the first side, can also be provided.

Depending on the application and the electrical assemblies to be connected, any combinations and numbers of connection faces can be provided on the connector body.

In an advantageous further development of the invention, it can be provided that the first connection face and the second connection face are arranged on opposite sides of the connector body.

The multi-way connector can then preferably be arranged between the electrical assemblies. Each of the assemblies can optionally provide a suitable contact force or plug-in force/contact normal force for sufficiently robust connection of the contact elements and mating contact elements.

According to a further development of the invention, it can be provided that the first connection face and the second connection face are arranged on sides of the connector body which are adjacent to one another via a common edge. Preferably, in this case, the first connection face runs orthogonally to the second connection face.

A combination of connection faces arranged on opposite sides of the connector body and adjacent connection faces of the connector body can also be provided, particularly if more than two electrical assemblies are to be connected to one another.

The multi-way connector can preferably be fastened to at least one or both/all assemblies, for example mechanically connected to a housing component of the assembly (or assemblies) via a detent connection. The multi-way connector can also be fastened to one or both/all of the assemblies solely via the connection between the contact elements and mating contact elements.

According to a further development of the invention, it can be provided that the film elements and/or the intermediate film structures of the connector body are connected to one another in an integrally bonded manner, at least in some regions.

Preferably, all adjacent film elements and/or intermediate film structures are connected to one another in an integrally bonded manner over their entire area, in particular are ultrasonically welded, laser welded, heat caulked and/or adhesively bonded.

In a preferred further development of the invention, it can be provided that exactly two of the film elements of the connector body form one of the film pairs in each case.

In the context of the invention, the intermediate film structure optionally present between the film elements of a film pair can also be considered to be part of the particular film pair. In this case, the film pair can also be referred to as a film composite.

In a further development of the invention, it can be provided that the contact elements each run between the mutually facing main faces of the film elements forming a film pair.

The “main faces” of a film element are to be understood here as the very large surfaces of the film compared to the thin side faces of the film. Preferably, the main faces of the film elements run orthogonally to the connection faces of the connector body.

In an advantageous further development of the invention, it can be provided that the contact portions of the contact elements protrude from the particular connection face.

The multi-way connector can thus contact the assemblies in a particularly robust manner, in particular if a mechanical connection is provided between the contact elements and mating contact elements.

Although it can be preferred if the contact portions of the contact elements protrude from the connection faces, it can also be provided in principle within the scope of the invention that the contact portions of the contact elements do not protrude from the particular connection face or run coplanar with the particular connection face. An inwardly offset design of the contact portions (for example in the manner of a socket contact) can also be provided, wherein the mating contact elements can then at least partially penetrate the connector body in order to establish the electrical contact.

According to a further development of the invention, it can be provided that the contact portions of the contact elements are formed as rounded contact heads, as contact pins, as contact assemblies of a plug connector and/or as soldering faces.

Rounded contact heads can be advantageous, for example, to compensate for a deviation in planarity between the electrical assemblies. The rounded contact heads can be semi-spherical or semi-ellipsoidal in shape, for example.

If contact heads are provided to form the contact portions, the contact heads can be designed, for example, to be mechanically connected to socket contacts of the corresponding mating contact elements of the associated assembly.

To fasten the contact elements to the mating contact elements, it can also be provided that the contact portions, in particular contact pins (but also contact heads), become soldered or are soldered to mating contact elements of the corresponding assembly that are designed as contact pads.

It is also possible to design the contact elements as socket contacts or socket contact assemblies or connectors or connector contact assemblies.

It can be provided that a contact element has different contact portions. For example, a contact element can have a contact head in the region of the first connection face and a contact pin in the region of the second connection face. Any combinations are possible.

It can additionally be provided that different contact elements of the connector body have differently designed contact portions. For example, it can be provided that a first group of contact elements has rounded contact heads and a second group of contact elements has contact pins. In principle, any combination of contact portions and contact elements is possible.

In particular, it can be provided that the multi-way connector is directly connected to one of the assemblies via the contact portions on one of the connection faces. For example, the multi-way connector can be directly attached by one of its connection faces to a printed circuit board and can be connected to the electrical circuit of the printed circuit board, for example by soldering or pressing the contact elements of the corresponding connection face to mating contact elements of the printed circuit board. Contact portions can then be provided on the second connection face, for example to allow insertion (or other connection) of a further electrical assembly.

It can also be provided that at least one of the contact portions, for example also both contact portions, are elastically designed or elastically mounted. For example, spring-loaded contact heads or spring-loaded/elastic contact pins can be provided. In particular, it can be provided that the contact elements each have at least one elastic portion that allows the contact element to be compacted along the longitudinal axis of the contact element. The contact element can thus be compressible in a defined manner along the longitudinal axis of the contact element, starting from the front end of the contact portion or the front ends of the contact portions.

The elasticity or deformability of the elastic portion or elastic portions of the contact element can be selected such that the contact element can compress sufficiently reversibly along its longitudinal axis during a mechanical connection process with one or more mating contact elements of one of the assemblies (or both/all assemblies) without undergoing (irreversible) plastic deformation. The elastic portion can compensate for expected tolerances in the positioning of the multi-way connector between the assemblies and can avoid tolerance-related damage to the contact elements. Due to the elasticity of the contact element in the elastic portion, sufficient contact pressure can be realized between the assemblies and the multi-way connector to compensate for mechanical tolerances and any vibrations during signal transmission.

Preferably, however, the contact elements, in particular the contact portions of the contact elements, are not elastic but rigid or inelastic.

In an advantageous further development of the invention, it can thus be provided that the contact elements, in particular the contact portions of the contact elements, are designed to be incompressible along the longitudinal axis of the contact element.

The mechanical fastening between the contact elements and the mating contact elements can thus be designed to be particularly stable and robust. In particular, a rigid contact element or a contact element with a rigid contact portion is particularly suitable for providing a plug connection with a corresponding mating contact element.

In a further development of the invention, it can be provided that the contact elements between the two connection faces have a zigzag course or an undulating course.

In the case of a curved or non-rectilinear geometry, the contact element can be particularly well accommodated in the connector body and thus secured against extraction. In principle, however, any design of the contact element along its longitudinal axis can be provided.

In a further development of the invention, it can be provided that an inner portion of the contact elements running between the two contact portions forms an electrical component or comprises an electrical component.

A suitable electrical component can be, for example, a resistor, preferably an ohmic resistor, an inductor or a coil, a capacitor, a semiconductor component (for example a diode or transistor), and/or an integrated circuit. In principle, any electrical component can be provided. It can also be provided that a contact element has, in its inner portion, a plurality of electrical components interconnected with each other.

Thus, simple signal processing or modifications can already be provided during signal transmission within the multi-way connector for the individual connections, for example, a filter function and/or impedance matching between the electrical connections.

In a further development of the invention, it can additionally be provided that an inner portion of the contact elements running between the two contact portions is designed to establish an electrical connection to at least one further inner portion of a further contact element.

The contact element can thus be designed in the manner of a throughplating in order to establish an electrical connection between different height levels or between different contact elements of different film pairs of the multi-way connector.

In a further development of the invention, it can be provided that a plurality or all of the contact elements are arranged in a row next to each other in a common film pair. Alternatively or additionally, it can be provided that a plurality or all of the contact elements in the connector body are arranged at different height levels and are distributed over a plurality of film pairs for this purpose.

For example, it can be provided that the connector body is primarily flat. For example, the connector body can have only one film pair, between which all of said contact elements are arranged side by side. The multi-way connector or the contact elements of the multi-way connector can thus be arranged in a single row.

It can also be provided that the connector body is primarily flat in that a plurality of film pairs are provided, between each of which only a few, for example only exactly one, of the contact elements are arranged. The contact elements of the multi-way connector can thus be arranged in only one column one below the other, for example in that the number of film pairs corresponds to the number of contact elements.

However, particularly preferred is a multi-way connector in which the contact elements are distributed in a row and column arrangement (corresponding to a matrix). Thus, a plurality of film pairs can be provided, between which a plurality of contact elements are arranged next to each other in each case. Thus, a three-dimensional grid arrangement of the contact elements is particularly preferred.

In a further development of the invention, it can be provided that the channel and the contact element are designed to interlockingly secure the contact element in the channel (in the longitudinal direction or along the longitudinal axis of the contact element) against withdrawal from the connector body.

For example, the channel (or the groove or recess) can have one or more ribs, lugs or other projections that engage with corresponding recesses in the contact element. Alternatively or additionally, it can also be provided that the contact element has one or more ribs, lugs or other projections which engage in corresponding recesses in the channel.

In a preferred embodiment, it can be provided that the channel is wider at its ends in the region of the connection faces than in an intermediate region lying therebetween. Correspondingly, the contact element can be wider in the region of its contact portions than in an intermediate portion (for example the elastic portion) in order to provide an interlocking fit on both sides in the longitudinal direction of the contact elements in the channel.

In an advantageous further development of the invention, it can be provided that the contact element is pressed and/or integrally bonded to at least one of the film elements of the film pair.

If necessary, the contact elements can adhere solely through the integrally bonded connection of the film elements of the film pair between the film elements.

In an advantageous further development of the invention, it can be provided that the contact portions of the contact elements are arranged in the first connection face according to a first pitch and are arranged in the second connection face according to a second pitch (preferably different from the first pitch).

Thus, a so-called “space translator” can be realized advantageously in order to match different pitches of different electrical assemblies by means of the multi-way connector. For example, the multi-way connector can thus match the pitches of two printed circuit board interfaces or of a semiconductor chip or chip housing and a printed circuit board interface.

The routing or pin assignment of the interface can also be adaptable between different electrical assemblies due to the multi-way connector.

In an advantageous further development of the invention, it can be provided that the connector body is fastened to at least one support body or is at least partially received in at least one support body to mechanically stabilize the connector body.

The connector body or the layered film elements can, for example, each be reinforced at their edges by a supporting body made of plastic, which is preferably thermoformed or manufactured in an injection molding process. The support body can be fastened to the connector body in an integrally bonded manner, interlockingly or in a frictionally engaged manner, for example by being pressed or adhesively bonded to the support body.

In a further development of the invention, it can additionally be provided that the connector body is received in an electrically conductive shielding housing to electromagnetically shield the connector body.

Preferably, the shielding housing extends along all faces of the connector body except the connection faces. The shielding housing can be made of a metal sheet or a metal-coated film. The shielding housing can be electrically connected to an outer conductor contact or ground contact of the multi-way connector and/or an outer conductor contact or ground contact of one or both/all assemblies. The shielding housing can be designed to electromagnetically shield not only the connector body but also the electrical connection between the contact elements and the mating contact elements.

In an advantageous further development of the invention, it can be provided that, for electromagnetic shielding of contact elements in the connector body, at least one of the film elements of one of the film pairs has a metal coating on a main face facing away from the contact elements. It can alternatively or additionally also be provided that a metal film or a metal sheet is arranged between at least two film pairs. It can alternatively or additionally also be provided that a shielding element is arranged between at least two of the contact elements of a common film pair.

Thus, electromagnetic shielding can also be advantageously possible between individual contact elements, which further optimizes the usability of the multi-way connector for high-frequency technology.

By shielding the connector body by means of the shielding housing and/or the contact elements from each other, in particular also an electrical connection comparable to a coaxial connection can be provided by the multi-way connector (or even a plurality of “coaxial” connections).

The invention also relates to an assembly connection, having a first electrical assembly and/or a second electrical assembly, as well as a multi-way connector for electrically contacting the assemblies, in particular for providing an electrical connection between the assemblies.

The multi-way connector is preferably formed as described above and hereinafter.

In principle, the assembly connection can also have more than two electrical assemblies that are contacted by the multi-way connector (and, for example, are connected to each other in any combination), for example three electrical assemblies, four electrical assemblies, five electrical assemblies, six electrical assemblies or even more electrical assemblies.

An assembly connection can advantageously be provided with a multi-way connector that is distinguished by a high number of individual contacts or contact elements with a small pitch and that can be produced economically even in large quantities.

For connection to the corresponding mating contact elements of the associated assembly, the multi-way connector can form any grid spacing between the individual contact elements at the corresponding connection face, for example a grid spacing of 10 mm or less, preferably 5 mm or less, particularly preferably 1 mm or less, very particularly preferably 0.6 mm or less, even more preferably 0.4 mm or less, for example also 0.1 mm or less.

The invention additionally relates to a method for producing a multi-way connector which is designed for making electrical contact with electrical assemblies (in particular for providing an electrical connection between the electrical assemblies). It is provided to insert, in parallel or sequentially, a plurality of contact elements into a connector body of the multi-way connector, said connector body having a plurality of film elements stacked on top of each other and connected to each other. The contact elements are inserted into the connector body in such a way that corresponding contact portions of the contact elements are arranged in the region of connection faces of the connector body for electrical contacting and mechanical fastening of corresponding mating contact elements. The film elements are connected to each other in an integrally bonded manner, at least in some regions.

Preferably, the contact elements are inserted into a connector body of a multi-way connector described above and hereinafter within the scope of the method according to the invention.

The following method steps can be provided:
a) inserting, in particular lying, at least one of the contact elements in a channel of one of the film elements (or creating a channel by pressing in the contact element), wherein the channel extends from a first side of the film element to a second side of the film element opposite the first side; and
b) producing a film pair by applying a further film element to the main face of the film element equipped with the contact element to form a connector body having a plurality of film elements stacked on top of each other, the connector body forming a first connection face coincident with the first sides of the film elements and a second connection face coincident with the second sides of the film elements.

It can be provided to construct a multi-way connector from individual layers of film elements. The individual layers or the individual film elements are preferably precisely superimposed and connected to one another. The electrical conductors or the contact elements can run between the individual laminate layers.

In a particularly advantageous way, multi-way connectors with a narrow pitch can be realized comparatively easily in accordance with the invention, in particular since the “manufacturing direction” along which the stacks of film elements are built up is orthogonal to the subsequent “working direction”, i.e. the longitudinal direction of the contact elements.

In a further development of the invention, it can be provided that the film elements are stacked on top of each other to produce the connector body in layers, wherein the contact elements are laid in the channels of the film pairs and/or pressed with the film elements during stacking of the film elements.

The realization of the layer principle according to the invention advantageously enables a continuous, in particular parallelizable manufacturing process. For example, a plurality of film elements of a plurality of multi-way connectors or a plurality of height levels of a multi-way connector can advantageously be prepared by parallel or joint stamping and/or cutting (for example, cut or stamped to size, possibly even with simultaneous incorporation or formation of grooves). Furthermore, a parallel insertion of a plurality of contact elements into film elements of a plurality of multi-way connectors or a plurality of height levels of a multi-way connector can be provided. Even the lamination or integral bonding of the individual, fitted film elements described below can be advantageously carried out in a single operation.

For example, it can be provided that a multi-way connector with a total of N height levels (“rows”) is produced by parallel conveying of N metal strips guiding the contact elements of a height level and 2N or N+1 film elements.

As already indicated, it can even be possible to produce a plurality of multi-way connectors at the same time if a plurality of film elements arranged in a row and a plurality of groups of contact elements of one height level arranged in a row are conveyed simultaneously. Preferably, at the end of the flow process, the multi-way connectors can be separated by means of separate cutting and/or stamping processes.

Advantageously, the layering of the individual film elements into film pairs according to the invention allows a channel (a groove or a recess) in at least one film element forming a film pair to be closed off to form a feedthrough through which a corresponding contact element runs. The need to provide a corresponding hole in the connector body for each individual contact element can thus be eliminated. Furthermore, it can be easier to insert the contact elements into the channels (preferably together) than to insert the contact elements later individually into the bores, as in the prior art.

Preferably, a one-part or multi-part contact element is inserted into the corresponding channel in each case.

Preferably, film elements with identical geometry are used. However, film elements with different geometries, for example different layer thicknesses or different surface formats, can also be provided in order to realize even more complex multi-way connectors. The use of composite films can also be provided.

The film elements can be connected to each other via respective connection strips. The film elements can, for example, be produced from an “endless film” and provided for the method for producing the multi-way connector. This also applies analogously to the intermediate film structure.

The connection strips can subsequently be removed, for example by cutting or stamping the connector body to its final shape.

In a further development of the invention, it can be provided that a plurality or all of the contact elements are inserted in a row adjacent to each other into a common film pair. The multi-way connector can thus have a plurality of columns of contact elements. Alternatively or additionally, it can be provided that a plurality of film pairs are created to distribute a plurality of contact elements in the connector body at different height levels. The multi-way connector can thus have a plurality of rows of contact elements.

Preferably, a multi-way connector is produced in accordance with the invention with multiple columns and with multiple rows of contact elements.

For example, it can be provided that the method steps of inserting the at least one contact element into the channel of a film element as well as the method step of creating a film pair by applying another film element (and optionally applying the intermediate film structure between the film elements of the film pair) are repeated a number of times in order to distribute a plurality of contact elements in the connector body over different height levels or rows.

It can optionally be provided that further film elements are inserted between film pairs, with no contact element being provided between said film elements.

In an advantageous further development of the invention, it can be provided that a plurality of contact elements connected via a carrier strip are applied together to a film element.

Preferably, the contact elements can thus first be connected to each other via a carrier strip or can already be produced accordingly. The contact elements can be available for the method for producing the multi-way connector, for example, as contact element “endless strips”.

The carrier strip can subsequently be removed, for example by cutting or stamping the connector body to its final shape.

In an advantageous further development of the invention, it can be provided that the contact elements are stamped out of a sheet material or are machined out of the sheet material by an etching process.

Laser cutting or laser beam cutting can also be well suited for cutting the contact element out of the sheet material. In particular, any separation process can be provided for working the contact element out of the sheet material.

The sheet material can in particular be a rolled metal product of which the width and length are much greater than its thickness. Preferably, a contact element is thus a metal sheet with preferably approximately “two-dimensional” dimensions.

However, it can also be provided for the contact element to be round, for example made of a wire. In principle, the contact element can be of any design. It can also be provided, for example, that the contact element comprises one or more electrical components or elements (resistors, capacitors, inductors, semiconductor functionalities, etc.).

For example, the contact element can also be produced micromechanically. For example, the contact element can be manufactured by an additive or subtractive process (for example, by a LIGA process, a 3D printing process or an MID (“Molded Interconnect Devices”) process). In principle, the contact element can be produced in any way, including, for example, by extrusion, thermoforming or turning.

It can be provided that the contact elements are at least partially adhesively bonded and/or welded to at least one film element forming a film pair.

If grooves are provided in the individual film layers or film elements, these can be made in the film elements by means of an embossing roller, for example.

In a further development of the invention, it can be provided that the film elements are connected in an integrally bonded manner by ultrasonic welding, laser welding, hot caulking and/or adhesive bonding of the main faces of the film elements (at least in some regions).

Preferably, the film elements are integrally bonded together individually. In principle, however, a plurality of film elements can also be connected together at the same time; in special exceptional cases, even all film elements can be connected together simultaneously in a joint process.

In an advantageous manner, the plastic films can be laminated together in an integrally bonded manner.

The invention also relates to a device for carrying out a method according to the above and following embodiments for producing a multi-way connector, which is designed for electrically contacting electrical assemblies (in particular for providing an electrical connection between the electrical assemblies). Preferably, the multi-way connector is designed as described above and below.

In particular, it can be provided that the device is designed to enable a flow process or flow production (also known under the terms continuous production/assembly or “continuous motion”), thereby enabling simple automation and significant increase in production volume or throughput.

This can result in a significant reduction in the unit cost per multi-way connector.

Thus, for example, it can be provided to construct a multi-way connector from a plurality of layered film elements which are laminated together or connected to each other in an integrally bonded manner. On at least one main face or surface of the individual film elements, one channel or a plurality of channels running adjacently to one another can optionally be formed. The corresponding contact elements can be inserted, preferably together, onto the individual film elements, optionally into the individual channels of the individual film elements.

Advantageously, in accordance with the invention, a multi-way connector, for example a backplane plug connector, can be provided on the basis of a laminate design.

The invention additionally relates to a use of a multi-way connector described above and hereinafter for providing an electrical connection between electrical assemblies, preferably between exactly two electrical assemblies.

Particularly preferably, the multi-way connector can be used advantageously as a so-called “backplane” plug connector, for example to insert a first assembly, designed as a plug-in assembly, into a second electrical assembly designed as a main circuit board and providing a plug-in slot.

The multi-way connector according to the invention can advantageously be used, for example, to provide an electrical connection between printed circuit boards of base stations of mobile radio systems.

The multi-way connector can also be used advantageously for testing integrated circuits or for testing printed circuit boards.

The multi-way connector can additionally be used particularly advantageously to connect between two electrical printed circuit boards, thus replacing known board-to-board connectors (also known as BTB connectors) with separate contacts.

The invention additionally relates to a computer program product for carrying out a method according to the foregoing and following embodiments, when the program is executed on a control unit of a device for producing a multi-way connector.

The control unit can be designed as a microprocessor. Instead of a microprocessor, any other device for implementing the control unit can also be provided, for example one or more arrays of separate electrical components on a printed circuit board, a programmable logic controller (PLC), an application-specific integrated circuit (ASIC) or any other programmable circuit, for example also a field programmable gate array (FPGA), a programmable logic array (PLA) and/or a commercially available computer.

Features which have been described in conjunction with the multi-way connector according to the invention can of course also be advantageously implemented for the assembly connection, the method, the device, the computer program product and the use according to the invention—and vice versa. Furthermore, advantages already mentioned in conjunction with the multi-way connector according to the invention can also be understood as relating to the assembly connection, the method, the device, the computer program product and the use according to the invention—and vice versa.

It should also be noted that terms such as “comprising”, “having” or “with” do not exclude other features or steps. Furthermore, terms such as “a” or “the” that indicate a singular number of steps or features do not exclude a plurality of features or steps—and vice versa.

However, in a purist embodiment of the invention, it can also be provided that the features introduced in the invention by the terms “comprising”, “having” or “with” are listed exhaustively. Accordingly, one or more listings of features can be considered exhaustive within the scope of the invention, for example, each considered for each claim. For example, the invention can consist solely of the features recited in claim 1.

Furthermore, it should be noted that the values and parameters described herein include deviations or fluctuations of ±10% or less, preferably ±5% or less, further preferably ±1% or less, and very particularly preferably ±0.1% or less of the particular designated value or parameter, provided that these deviations are not excluded in the implementation of the invention in practice. The specification of ranges by initial and final values also includes all those values and fractions which are included by the particular designated range, in particular the initial and final values and a corresponding mean value.

Exemplary embodiments of the invention are described in more detail below with reference to the drawing.

The figures each show preferred exemplary embodiments in which individual features of the present invention are shown in combination with one another. Features of one exemplary embodiment can also be implemented separately from the other features of the same exemplary embodiment and can accordingly be readily combined by a person skilled in the art to form further useful combinations and sub-combinations with features of other exemplary embodiments.

In the figures, functionally identical elements are provided with the same reference signs.

They show schematically:

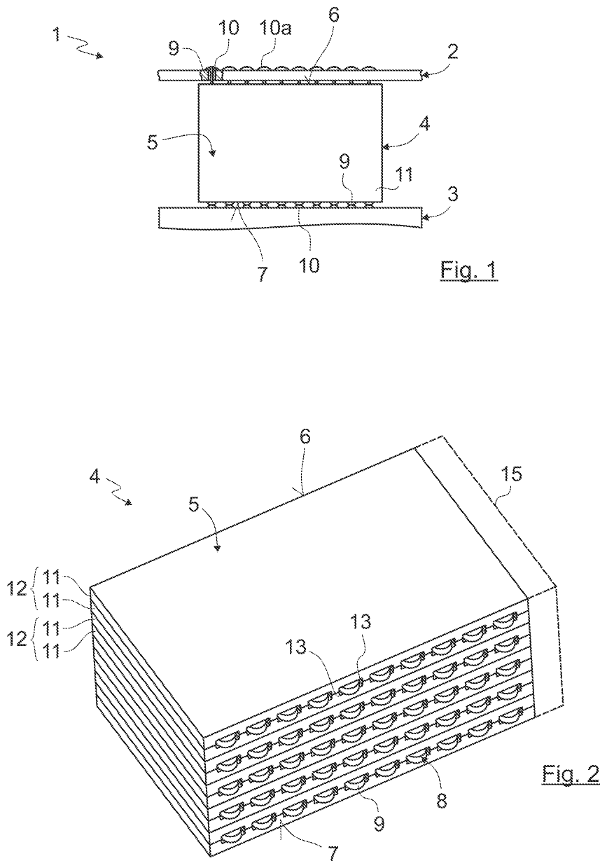

FIG. 1 an assembly connection according to the invention with a first electrical assembly, a second electrical assembly and a multi-way connector according to the invention in accordance with a first exemplary embodiment;

FIG. 2 a multi-way connector according to a second exemplary embodiment in a perspective view;

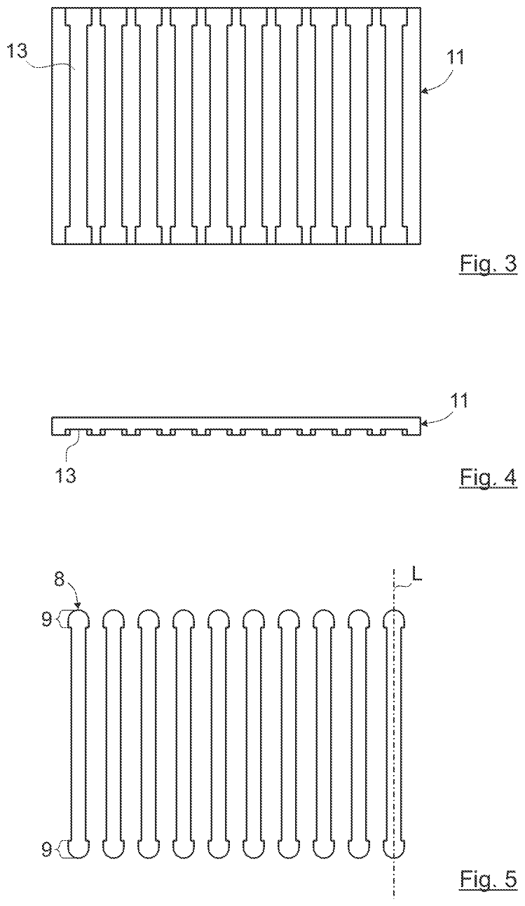

FIG. 3 one of the film elements of the connector body of the multi-way connector of FIG. 2 in a plan view of one of the two main faces, with grooves embossed in the main face of the film element for receiving contact elements;

FIG. 4 a side view of the film element of FIG. 3;

FIG. 5 a plan view of the contact elements of a common height position of the multi-way connector of FIG. 2;

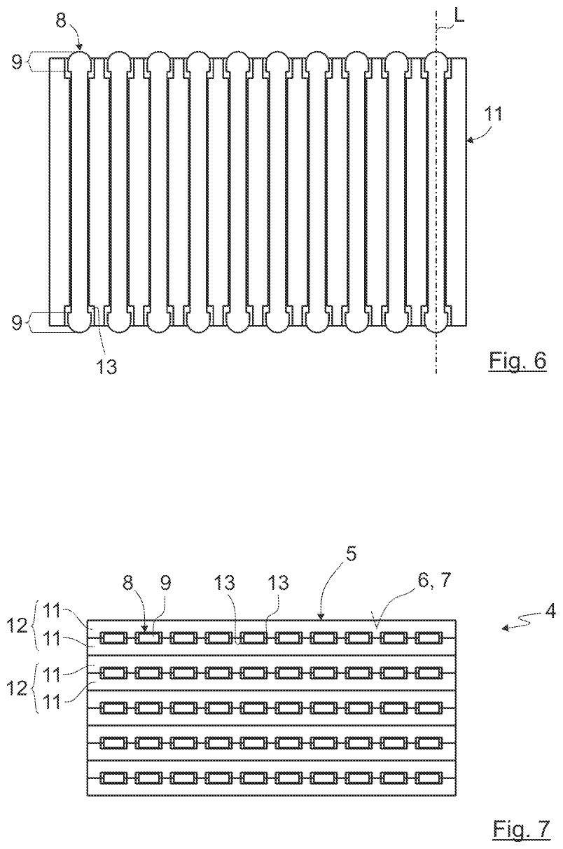

FIG. 6 a plan view of the film element of FIG. 3 with the contact elements of FIG. 5 laid in the grooves;

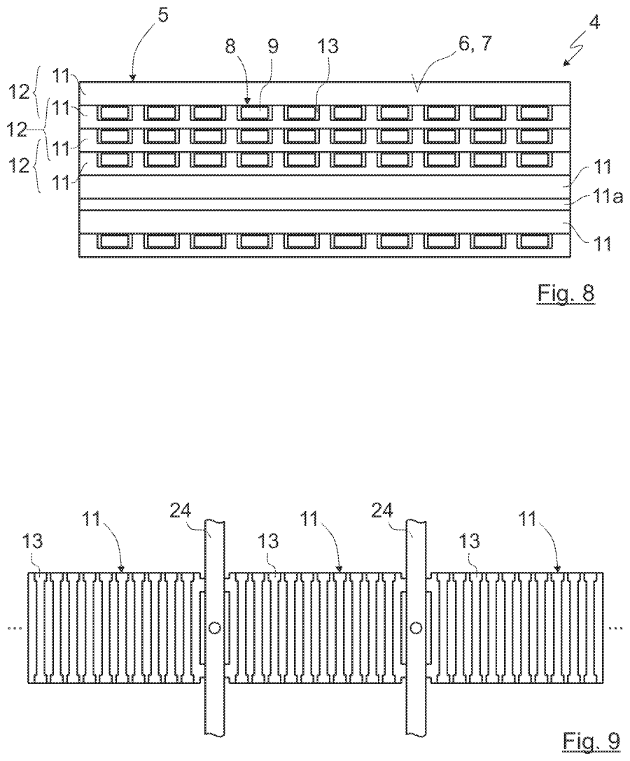

FIG. 7 the multi-way connector of FIG. 2 in a side view of one of the connection faces;

FIG. 8 a side view of one of the connection faces of a multi-way connector according to the invention in accordance with a third exemplary embodiment;

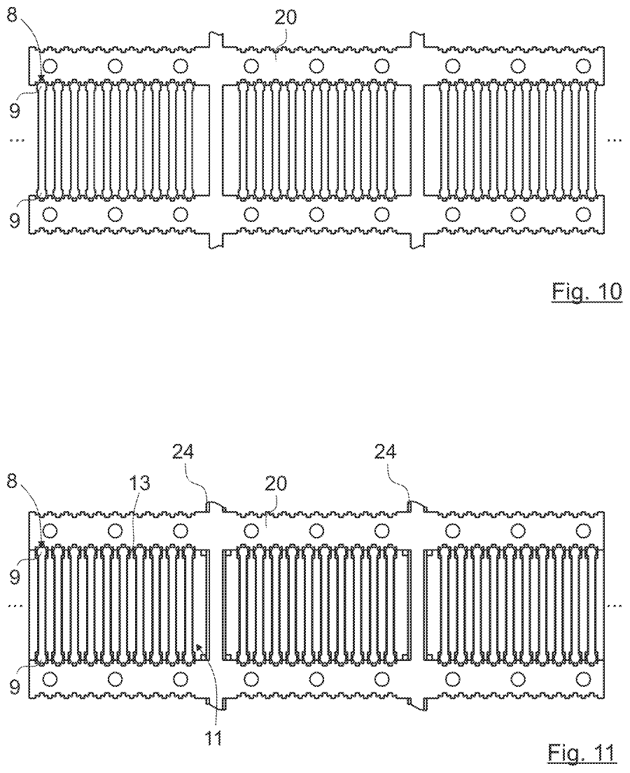

FIG. 9 a plan view of a plurality of film elements connected to each other via respective connection strips according to FIG. 3;

FIG. 10 a plan view of a plurality of contact elements connected to each other via a carrier strip, each with a common height position as shown in FIG. 5;

FIG. 11 a plan view of the contact elements of FIG. 10 laid together in the film elements of FIG. 9;

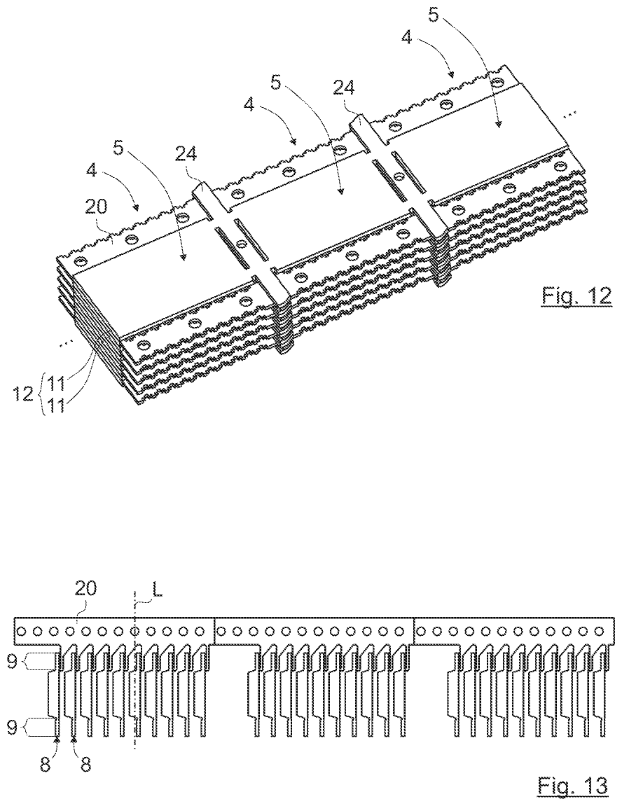

FIG. 12 a stack of a plurality of film elements and contact elements, with the respective connection strips and carrier strips for a multi-way connector according to FIG. 2 in a perspective view;

FIG. 13 a plurality of contact elements of a particular common height position connected to each other via a carrier strip and having pin-shaped contact portions;

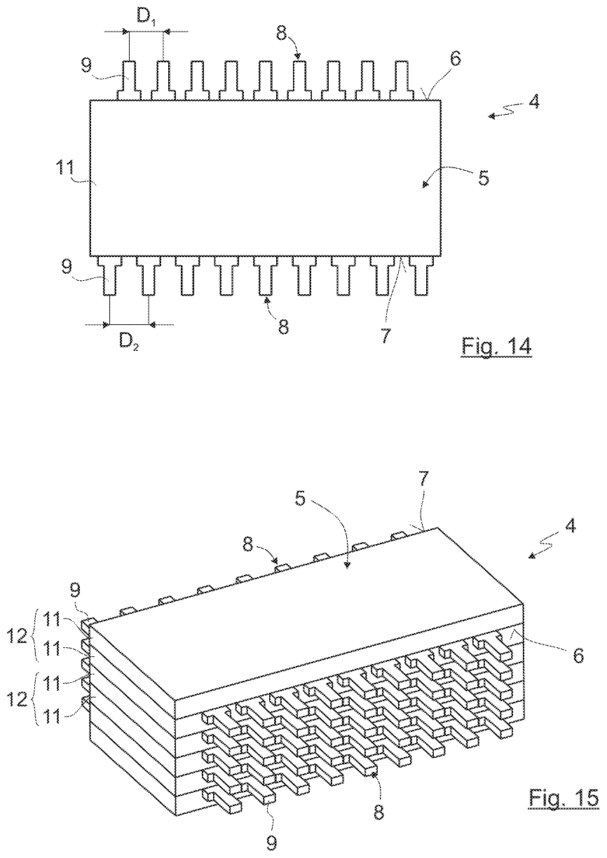

FIG. 14 a plan view of a multi-way connector according to the invention in accordance with a fourth exemplary embodiment with connection faces with different pitches;

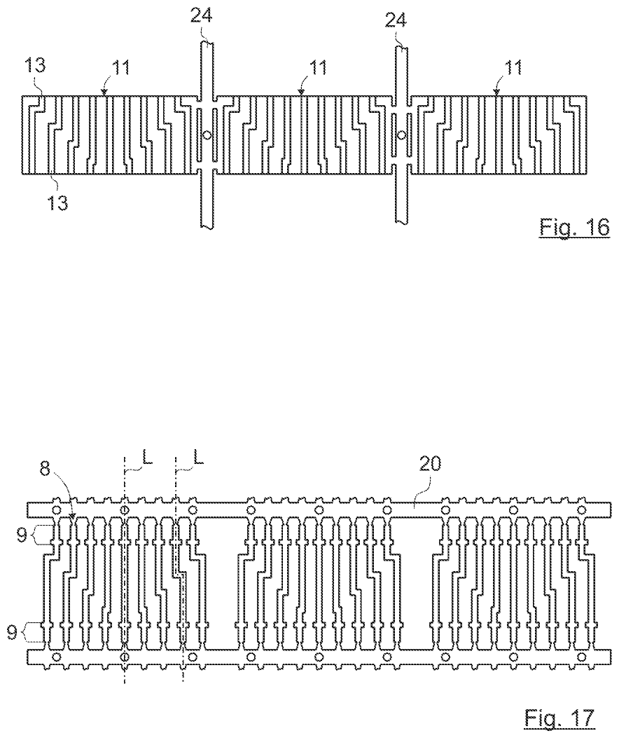

FIG. 15 the multi-way connector of FIG. 14 in a perspective view;

FIG. 16 a plurality of film elements connected to each other via respective connection strips for a multi-way connector according to FIG. 14 in a plan view of one of the two main faces, with grooves embossed in the main face of the film element for receiving contact elements;

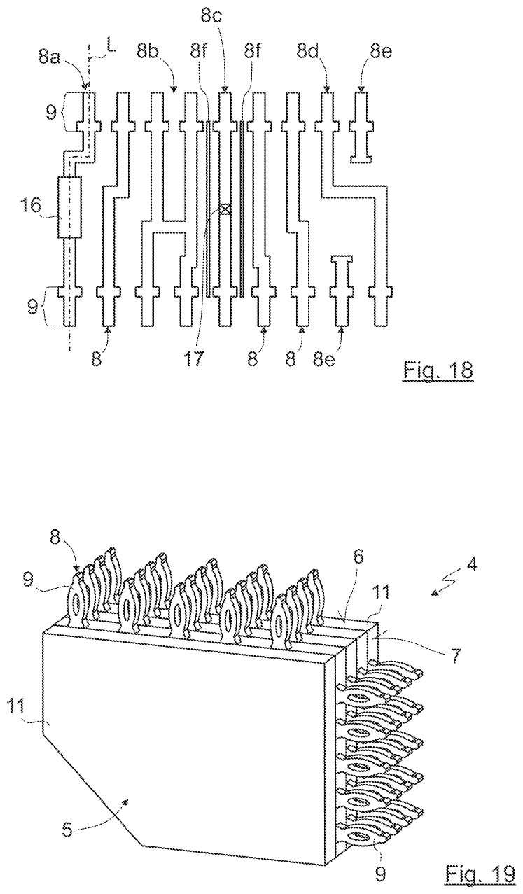

FIG. 17 a plan view of a plurality of contact elements of a particular common height position connected to each other via a carrier strip for a multi-way connector according to FIG. 14;

FIG. 18 a plan view of an exemplary assembly of various contact elements and two shielding elements;

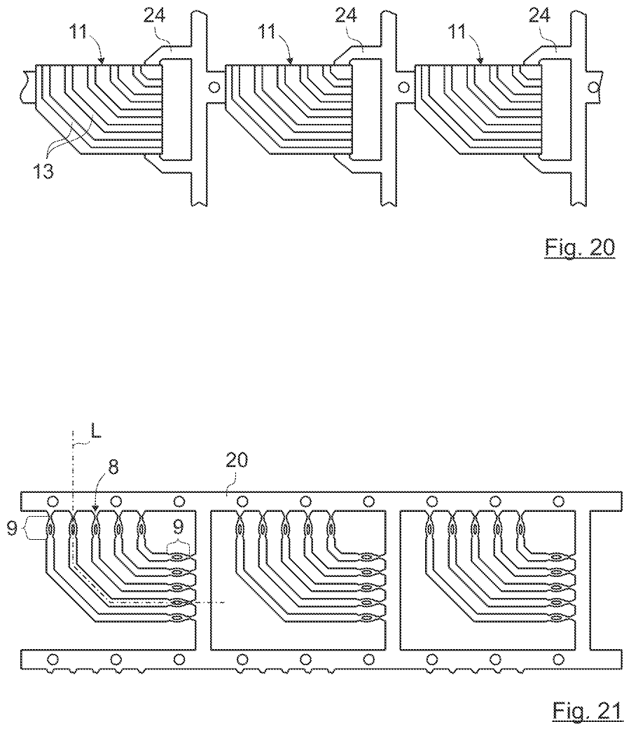

FIG. 19 a multi-way connector according to the invention in accordance with a fifth exemplary embodiment with connection faces arranged orthogonally to one another in a perspective view;

FIG. 20 a plurality of film elements connected to each other via respective connection strips for a multi-way connector according to FIG. 19 in a plan view of one of the two main faces, with grooves embossed in the main face of the film element for receiving contact elements;

FIG. 21 a plan view of a plurality of contact elements of a particular common height position connected to each other via a carrier strip for a multi-way connector according to FIG. 19;

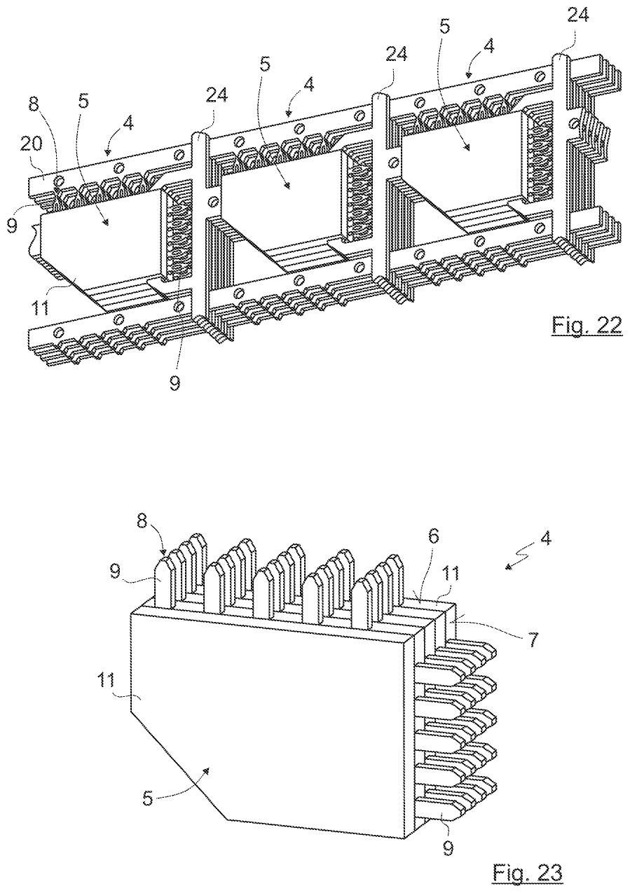

FIG. 22 a stack of a plurality of film elements and contact elements, with the respective connection strips and carrier strips for a multi-way connector according to FIG. 19 in a perspective view;

FIG. 23 a multi-way connector according to the invention in accordance with a sixth exemplary embodiment with connection faces arranged orthogonally to one another in a perspective view;

FIG. 24 a multi-way connector according to the invention in accordance with a seventh exemplary embodiment with connection faces arranged orthogonally to one another in a perspective view;

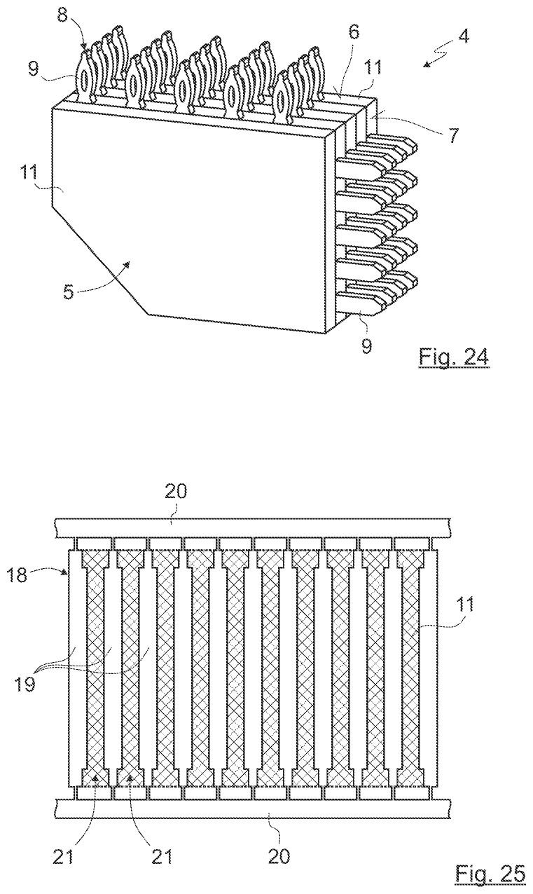

FIG. 25 a plan view of a film element for a multi-way connector with an intermediate film structure applied to the film element to form recesses between individual film segments of the intermediate film structure;

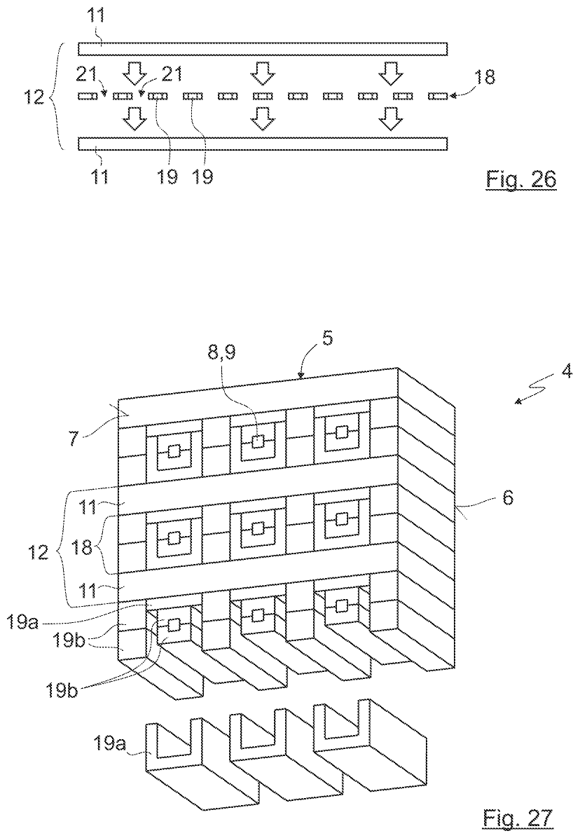

FIG. 26 a side view of a film pair consisting of two film elements and an intermediate film structure arranged between the film elements in accordance with FIG. 25;

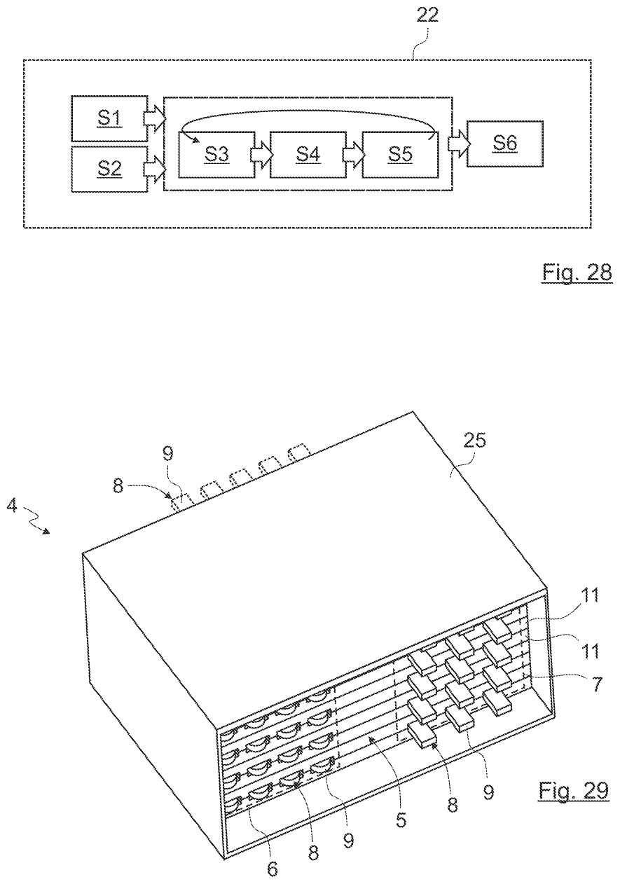

FIG. 27 a connection body with an intermediate film structure arranged between the film elements forming a film pair, in the intermediate film structure having conductive and insulating film segments to electrically shield the contact elements in each case in the manner of a coaxial line;

FIG. 28 a flow chart of a process for producing a multi-way connector with some exemplary method steps;

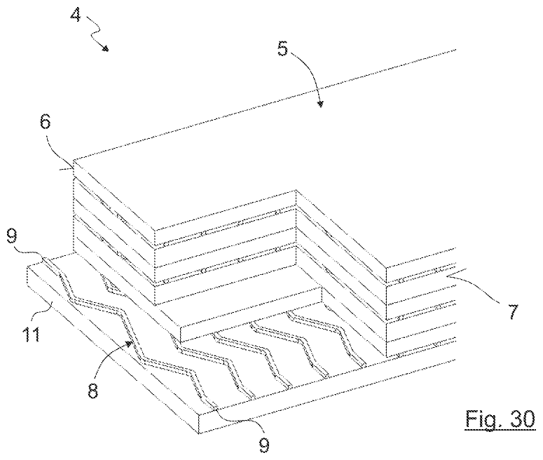

FIG. 29 a multi-way connector according to the invention in accordance with an eighth exemplary embodiment for electrically contacting electrical assemblies via connection faces arranged on the same side of the connector body and having a shielding housing; and

FIG. 30 a multi-way connector according to the invention in accordance with a ninth exemplary embodiment with zigzag contact elements that are not laid in corresponding channels of the film elements.

FIG. 1 shows an assembly connection 1, having a first electrical assembly 2, a second electrical assembly 3 and a multi-way connector 4 for electrically contacting the assemblies 2, 3. The multi-way connector 4 serves in particular to provide an electrical connection between the assemblies 2, 3.

The electrical assemblies 2, 3 can, for example, be electrical circuits accommodated in respective device housings, printed circuit boards equipped with respective electrical circuits, integrated circuits and/or circuit housings for accommodating and connecting to a corresponding integrated circuit. In principle, any types of assemblies in any combinations are possible. For example, the multi-way connector 4 can be used as a plug connector for a backplane application or as a board-to-board connector.

The multi-way connector 4 has a connector body 5 with a first connection face 6 and with a second connection face 7. The connection faces 6, 7 are arranged on opposite sides of the connector body 5. In principle, however, the connection faces 6, 7 can also be arranged on the same side of the connector body 5, as will be shown below with reference to the exemplary embodiment of FIG. 29.

The multi-way connector 4 additionally has a plurality of electrical contact elements 8 (see, for example, FIG. 5), which extend from the first connection face 6 to the second connection face 7 through the connector body 5. In the region of the connection faces 6, 7, the contact elements 8 each have respective contact portions 9 for electrically contacting corresponding mating contact elements 10 of the associated assembly 2, 3.

The contact portions 9 on at least one of the connection faces 6, 7 are designed in accordance with the invention to be mechanically fastened to the mating contact elements 10. In particular, the contact portions 9 can also be different. For example, the contact portions 9 on the two connection faces 6, 7 can each be designed differently, as shown in FIG. 1.

In FIG. 1, pin-shaped contact portions 9 are provided as an example on the first connection face 6 for connection or soldering to contact pads 10a of a first assembly 2 designed as a printed circuit board. The mating contact element 10 of the first assembly 2 is thus formed as a throughplating in the printed circuit board to receive the pin-shaped contact portions 9 of the multi-way connector 4. At the second connection face 7, on the other hand, the contact portions 9 are formed as rounded contact heads in order to make contact with corresponding mating contact elements 10 of the second assembly 3 on the end-face side. The contact heads (of the contact portions 9 and/or mating contact elements 10) can optionally be spring-loaded.

A multi-way connector 4 according to a second exemplary embodiment of the invention is shown in FIGS. 2 to 7. FIG. 2 shows the multi-way connector 4 in a perspective view; FIG. 7 shows a plan view of one of the connection faces 6, 7. The multi-way connector 4 according to the second exemplary embodiment has identically formed contact portions 9 in the manner of rounded contact heads on both connection faces 6, 7.

As can be seen particularly well from FIGS. 2 and 7, the connector body 5 of a multi-way connector 4 according to the invention has a plurality of film elements 11 stacked on top of one another and at least partially integrally bonded to one another. In each case, two of the film elements 11 form a film pair 12, between the mutually facing main faces of which the contact elements 8 run.

It can be provided that the film pairs 12 each form corresponding channels for the contact elements 8. In the exemplary embodiments of FIGS. 2 to 22, the channels are formed as grooves 13 in at least one of the film elements 11 of the film pair 12. The exemplary embodiments shown in FIGS. 25 to 27 show another way of forming the channels, although this will be described later. The channels can also be formed only by pressing the film elements 11 with the contact elements 8, which will be described in more detail below. If necessary, the channels can also be completely omitted (see FIG. 30).

As already mentioned, each of the contact elements 8 can thus be inserted into a corresponding groove 13 formed in at least one of the film elements 11—in the exemplary embodiment shown in FIGS. 2 to 7, in both film elements 11—of one of the film pairs 12.

To better illustrate the invention, one of the film elements 11 is shown in a plan view in FIG. 3 and in a side view in FIG. 4. FIG. 5 shows the contact elements 8 of a height level/row or the contact elements 8 which are inserted together between two of the film elements 11 or in a film pair 12. In FIG. 6, the contact elements 8 are shown in their state laid in the grooves 13 of one of the film elements 11.

The contact elements 8 can have a rigid portion between the two contact portions 9 (see in particular FIG. 5), which extends linearly or rectilinearly between the connection faces 6, 7.

For contacting the mating contact elements 10 of a particular assembly 2, 3, the contact portions 9 in the exemplary embodiment protrude from the particular connection face 6, 7 (see for example FIG. 2 or FIG. 6). In principle, however, a coplanar design can also be provided, according to which the contact portions 9 terminate flush with the corresponding connection face 6, 7 (see FIG. 27 or FIG. 30). Even an inwardly offset design of the contact portions 9 in the manner of a socket contact can be provided, wherein the mating contact elements 10 of the assemblies 2, 3 can then be inserted at least partially into the corresponding connection face 6, 7.

In the exemplary embodiments according to FIGS. 1 to 12 and 29, the contact portions 9 of the contact elements 8 have rounded contact heads. In principle, however, the contact portions 9 can be of any design, for example also as contact pins (see FIGS. 1, 13 to 18, 23, 24 and 29) or plug-in contacts (see FIGS. 19 to 22 and 24).

In order to interlockingly secure the contact element 8 in the channel or in the groove 13 in the longitudinal direction or along the longitudinal axis L of the contact element 8 against being pulled out of the connector body 5, the channel or the groove 13 can have a recess and can, for example be thinner in a central region than in the outer regions at the connection faces 6, 7, as a result of which the contact heads of the contact elements 8 can produce a form fit with the groove 13 and the contact elements 8 can no longer be removed from the channel or from the groove 13 after the film elements 11 have been connected.

In an optional embodiment, at least one supporting body 15 can be provided to reinforce the connector body 5. In FIG. 2, a supporting body 15 is indicated in dashed lines on a side face of the connector body 5 adjacent to the connection faces 6, 7. In principle, it can also be provided that the connector body 5 is at least partially accommodated in at least one supporting body. The connector body 5 can be mechanically stabilized by the at least one supporting body 15, for example if the stacked film elements 11 do not already have sufficient mechanical stability themselves.

The exemplary embodiments show exemplary multi-way connectors 4 of which the contact elements 8 are arranged in rows and columns, in the manner of a matrix. In principle, however, it is also possible for a multi-way connector 4 in the context of the invention to have only contact elements 8 in a row, which are inserted next to one another in corresponding channels or grooves 13 of only one film pair 12. A multi-way connector 4 can thus in principle also have only one film pair 12. Accordingly, it can also be provided that a multi-way connector 4 has only a single contact element 8 per film pair 12 and thus a plurality of individual contact elements 8 are stacked on top of each other and separated from each other by the film elements 11 lying in between.

In contrast to the exemplary embodiment of the invention shown in FIGS. 1 to 7, it can also be provided that only one of the film elements 11 of a film pair 12 has a groove 13 for receiving a corresponding contact element 8, as shown in FIG. 8. Thus, individual film elements 11 can also form a film pair 12 in each case with two further film elements 11. This is a preferred variant, since the embossing of the groove 13 then only has to be carried out in one of the two film elements 11 of a film pair 12, which can further simplify production. The exemplary embodiments shown in FIGS. 14 to 22 also feature, by way of example, a film pair 12 with only one groove 13 in one of the two film elements 11 forming the film pair 12.

Furthermore, it can be provided that further film elements 11 are arranged between film pairs 12 without enclosing a contact element 8 or a plurality of contact elements 8 with other film elements 11, as also indicated in FIG. 8. This can serve, for example, for a more flexible adaptation of the pitch of the connection faces 6, 7. For better adaptation of the pitch, it can also be provided that film elements 11 with different thicknesses are used.

Metal films 11a or metal sheets can also be provided between individual film elements 11, in particular between film pairs 12. This allows the contact elements 8 of different height levels in the connector body 5 to be electromagnetically shielded from each other. Instead of a metal film 11a or a metal sheet, it is also possible to provide at least one of the film elements 11 with a metal coating or to use one or more composite films.

An advantageous use of the multi-way connector 4 according to the invention can also be the harmonization of different pitches of the assemblies 2, 3 to be connected to each other. A corresponding multi-way connector 4, which can also be referred to as a “space translator”, is shown in FIGS. 14 to 17.

As can be seen particularly well from FIG. 14, the first connection face 6 of the connector body 5 has a first pitch (see first distance Di between the contact elements 8 of the first connection face 6), whereas the second connection face 7 has a second pitch (see second distance D₂ between the contact elements 8 of the second connection face 7).

Corresponding film elements 11 with channels (again formed for example by corresponding grooves 13) are shown in FIG. 16. FIG. 17 shows the corresponding contact elements 8 for harmonizing the pitch, which can be inserted into the grooves 13 of the film elements 11 of FIG. 16.

The contact elements 8 can therefore in principle be of any complexity and do not necessarily have to follow a strictly linear course along their longitudinal axis L as in the previously described exemplary embodiments. To illustrate some particularly advantageous designs of contact elements 8, an exemplary combination of different contact elements 8 is shown in FIG. 18.

For example, a contact element 8 can be provided that has an electrical component 16 (for example a resistor, an inductor, a capacitor, a semiconductor component, or an integrated circuit). In principle, the contact element 8 can even comprise a plurality of interconnected electrical components 16. FIG. 18 shows an example of a contact element 8a with an electrical component 16 arranged between the two contact portions 9.

It can also be provided to use contact elements 8b (see FIG. 18) which have more than two contact portions 9, for example four contact portions 9, in particular two contact portions 9 per connection face 6, 7. Such a contact element 8b can, for example, be formed by two individual contact elements 8 which are electrically connected to each other, as shown in the middle portion of the contact element 8b of FIG. 18.

Furthermore, it can be provided that a contact element 8 is designed to establish an electrical connection to at least one further contact element 8 of another height level of the connector body 5, in the manner of a throughplating. A corresponding contact element 8c is also shown as an example in FIG. 18. The contact element 8c has in its central portion a contact tip 17 (preferably) running parallel to the connection faces 6, 7 and orthogonal to the main faces of the film elements 11, which is designed to pierce the film elements 11 running above the contact element 8c in order to contact a correspondingly higher contact element 8.

Lastly, contact elements 8 can also be used to harmonize the pin assignment between the connection faces 6, 7. FIG. 18 shows an example of a contact element 8d for swapping two lines between the connection faces 6, 7.

Dummy contact elements 8e can also be provided, for example if individual mating contact elements 10 of the corresponding assembly 2, 3 are not present, are not assigned or are not to be electrically connected.

As also demonstrated by way of example in FIG. 18, shielding elements 8f can also be provided, which are inserted between individual contact elements 8 or between groups of contact elements 8 (optionally also in corresponding channels) in order to electromagnetically shield contact elements 8 of a common height level from each other. The shielding elements 8f can be simple metal parts or sheet parts, for example.

In the exemplary embodiments described so far, the connection faces 6, 7 were always arranged on opposite sides of the connector body 5 in order to connect the first assembly 2 to the second assembly 3. However, this is not to be understood restrictively. In particular, the connection faces 6, 7 can also be arranged on sides of the connector body 5 that adjoin one another via a common edge, in particular on sides that run orthogonally to one another, as illustrated by way of example in the exemplary embodiments shown in FIGS. 19 to 24.

FIG. 19 shows a perspective view of an angled multi-way connector 4. The film elements 11 which can be advantageously used to form a suitable connector body 5 are shown in FIG. 20 and corresponding contact elements 8 accordingly in FIG. 21. Lastly, FIG. 22 shows a stack formed from the film elements 11 and the contact elements 8.

The contact portions 9 of the contact elements 8 of the multi-way connector 4 shown in FIGS. 19 to 22 are identical on both connection faces 6, 7 and are designed in the manner of plug-in contacts in order to latch mechanically with corresponding mating contact elements 10 of the particular assembly 2, 3. FIG. 23 shows a further angled multi-way connector 4 with contact portions 9 in the form of pin contacts on both connection faces 6, 7. Lastly, FIG. 24 shows a further exemplary angled multi-way connector 4 with plug-in contacts on the first connection face 6 and pin contacts on the second connection face 7.

The connection faces 6, 7 can in principle be provided on any sides of the connector body 5. The use of more than two connection faces 6, 7 for electrically contacting more than two assemblies 2, 3 is also possible within the scope of the invention.

A further possibility for forming the channels in the film pairs 12 for inserting the contact elements 8, already indicated above, is shown in FIGS. 25 and 26. In this case, it can be provided to apply an intermediate film structure 18 to at least one of the film elements 11 forming a film pair 12. The intermediate film structure 18 can comprise, for example, a plurality of film segments 19. FIG. 25 shows a plan view of a film element 11 (shown in dashed lines and cross-hatched for better representation) to which an intermediate film structure 18 has been applied, for example laid on. The individual film segments 19 are connected to one another by carrier strips 20 in order to simplify the application of the intermediate film structure 18—however, this is not absolutely necessary. Lastly, recesses 21 remain between the film segments 19 to form the channels for inserting the contact elements 8.

FIG. 26 shows, for further clarification, the structure of a single film pair 12 with the intermediate film structure 18. The intermediate film structure 18 is located between the two film elements 11 after the film elements 11 have been joined together. The carrier strip 20 is hidden for better illustration. Preferably, the contact elements 8 are still inserted into the recesses 21 before the film pair 12 is completed by applying the second film element 11 (also not shown).

To demonstrate the versatility of the potential uses of the multi-way connector 4 according to the invention, FIG. 27 shows a multi-way connector 4 with a particularly complex connector body 5. The individual contact elements 8 are electrically shielded in a manner comparable to a coaxial line. The multi-way connector 4 is thus designed in the manner of a coaxial multi-way connector 4. This allows the multi-way connector 4 to have particularly good electromagnetic compatibility and/or to be well suited for transmitting high-bit-rate data signals or for transmitting signals for high-frequency technology.

Once again, two film elements 11 each form a film pair 12. An intermediate film structure 18 is again provided between the film elements 11, although its structure is more complex than shown in FIGS. 25 and 26. In principle, the intermediate film structure 18 can have electrically conductive film segments 19a (for example, metal film segments 19a) and electrically non-conductive film segments 19b (for example, plastic film segments 19b) within the scope of the invention. In FIG. 27, the film segments 19a, 19b are suitably combined in a manner that results in the quasi-coaxial structure of the multi-way connector 4. Lastly, the middle non-conductive film segments 19b form the channel for the contact element 8. In FIG. 27, the contact elements 8 have coplanar contact portions 9. In principle, however, any contact element 8 can be provided for the coaxial structure.

It should be emphasized that FIG. 27 shows only one of many more complex examples of a multi-way connector 4 according to the invention. It should also be mentioned that the multi-way connector 4 can also be suitable for high-frequency technology if the multi-way connector 4 does not have a coaxial or quasi-coaxial structure. For example, differential signal routing through the multi-way connector 4 can also ensure high-bit-rate data transmission. In principle, of course, any signals with any signal transmission type can be transmitted through the multi-way connector 4.

The invention also relates to a method for producing a multi-way connector 4. An exemplary method sequence is shown in FIG. 28. The method can be carried out in a suitable device 22. For example, a computer program product with program code means can also be provided for this purpose.

In a first method step S1, it can be provided to stamp out the contact elements 8 from a sheet material. Alternatively, the contact elements 8 can also be produced by an additive method or a subtractive method.

The contact elements 8 can be stamped out here in such a way that they are connected to each other via a carrier strip 20 (see, for example, FIGS. 10, 13, 17 and 21). In contrast to, for example, the design in FIG. 10, it can also be possible for the carrier strip 20 to be fastened to the contact elements 8 on one side only, as shown in FIG. 13. By using a carrier strip 20, the interconnected contact elements 8 can later be inserted into the film elements 11, for example into the respective channels or into the grooves 13 or into the recesses 21, particularly advantageously in a common process.

In a second method step S2, which can be carried out in parallel with the first method step S1, it can be provided to form the film elements 11.

It can be provided, for example, that the film elements 11 are stamped or cut out from a plastic film, wherein a plurality of film elements 11 can optionally be connected to each other via connection strips 24 (see, for example, FIGS. 9, 16 and 20). The film elements 11 can thus be used as an endless film for the method.

The optional groove 13 can be inserted into at least one of the main faces of the film elements 11, for example by an embossing roll or other embossing method, or by a subtractive method.

Instead of through a groove 13, an optional channel can also be realized using the intermediate film structure 18, as already described. For this purpose, the intermediate film structure 18 as well as the film elements 11 can, for example, first be stamped or cut out from a plastic film, wherein carrier strips 20 preferably remain, which initially still connect the individual film segments 19 to one another (see FIG. 25). The intermediate film structure 18 can thus also preferably be produced as an “endless film”.

The first method step S1 and the second method step S2 are optional within the scope of the invention.

Within the scope of the method according to the invention, it can be provided in a third method step S3 that at least one of the contact elements 8 is applied to one of the film elements 11, for example laid in one of the channels (for example into one of the grooves 13 in a main face of one of the film elements 11). Preferably, a plurality of contact elements 8 can be applied to one film element 11 at the same time. In this way, a plurality of multi-way connectors 4 can also be produced simultaneously. The principle is illustrated, for example, with reference to FIGS. 9 to 11. The contact elements 8 of FIG. 10, which are connected to one another via the carrier strip 20, are laid together in the film elements 11 of FIG. 9, which are connected via the connection strips 24, as shown in FIG. 11.

Subsequently, in a fourth method step S4, a film pair 12 can be created by applying another film element 11 to the main face of the film element 11 equipped with the contact element 8. This allows a plurality of film elements 11 stacked on top of each other to form the connector body 5 shown.

In particular, a plurality of film pairs 12 can be produced in order to distribute a plurality of contact elements 8 in the connector body 5 at different height levels. The third method step S3 and the fourth method step S4 can be repeated a number of times for this purpose, for example. FIG. 12 shows an example of a corresponding stack of film pairs 12.

The method according to the invention can advantageously be parallelized. For example, a plurality of multi-way connectors 4 can be formed simultaneously, as indicated in FIGS. 9 to 12. Furthermore, a plurality of height levels of film elements 11 and contact elements 8 can be guided in a corresponding device 22 already running in parallel and at the same speed one above the other.

In a fifth method step S5, the film elements 11 can be at least partially integrally bonded to one another, preferably by ultrasonic welding, laser welding, hot caulking and/or adhesive bonding of the main faces of the film elements 11. Preferably, the film elements 11 are connected to one another successively during stacking. Thus, in a preferred embodiment, the method steps S3 to S5 can be repeated accordingly a number of times. However, it can also be possible to integrally bond more than two film elements 11 to one another at the same time.

Lastly, in a sixth method step S6, individual connector bodies 5 or individual multi-way connectors 4 can be cut or stamped out for a precise fit, for example from an endless strip. With reference to the illustrations in FIGS. 9 to 12, three multi-way connectors 4 can be produced simultaneously, for example.

The sixth method step S6 is optional within the scope of the invention.

It should be noted that the method sequence described above is to be understood as merely exemplary. In particular, individual method steps can be omitted, interchanged in sequence or subdivided into further individual steps. Individual method steps can additionally also be combined. Further method steps can also be provided.

For example, it can also be provided to first build up the connector body 5 without the contact elements 8 by stacking and connecting the film elements 11 (and, as applicable, the intermediate film structures 18) and only then to insert the contact elements 8 into the channels.

Lastly, FIG. 29 shows another example of a multi-way connector 4 according to the invention, in which the connection faces 6, 7 are arranged on the same side of the connector body 5. The corresponding side face is divided here into a plurality of regions which form the connection faces 6, 7. In principle, any number of connection faces can be distributed on the common side face. The connection faces can be distributed over the side face in any desired manner.

By way of example, the multi-way connector of FIG. 29 also has differently formed contact portions 9 and additionally also a different number of contact elements 8 in the respective connection faces 6, 7.

A multi-way connector 4 according to the invention can optionally also be accommodated in a shielding housing 25 in order to electromagnetically shield the connector body 5 and optionally also the plug connection between the multi-way connector 4 and the assemblies 2, 3. This is also shown as an example in FIG. 29. The shielding housing 25 surrounds the connector body 4 as completely as possible, wherein the connection faces 6, 7 generally remain accessible. The shielding housing 25 can be formed, for example, by a metal sheet and/or a metal coating of the outermost film elements 11 and/or the side faces of the connector body 5. In order to also shield the plug connection between the multi-way connector 4 and the electrical assemblies 2, 3, the shielding housing 25 can project at least partially beyond the connector body 5 in the plug-in direction, which is also indicated in FIG. 29.

The multi-way connector 4 according to FIG. 29 can be used, for example, as a multiple contact bridge to electrically bridge two assemblies 2, 3 (for example two printed circuit boards), wherein the contact elements 8 can then run through the multi-way connector 4, in particular in a U-shape.

FIG. 29 also shows, by dashed lines, contact elements 8 on the side of the multi-way connector 4 opposite the two connection faces 6, 7, said contact elements being able, for example, to be arranged in at least one further, third connection face (not shown in more detail). The multi-way connector 4 can then be designed, for example, to establish an electrical connection between a plurality of circuits to be tested and a test system, in order to forward test signals from the test system to the individual circuits and output signals from the circuits to be tested to the test system. For example, the test system can be connected to the multi-way connector 4 via the contact elements 8 of the third connection face. By means of such a multi-way connector 4, a plurality of circuits or assemblies 2, 3 can be contacted simultaneously in an advantageous manner, which can significantly reduce the test duration. A reduction in the test duration is desirable in particular for economic reasons in mass production.

As already mentioned, the channels of the film elements 11 for inserting the contact elements 8 can also be dispensed with completely if necessary. A corresponding multi-way connector 4 is shown as an example in FIG. 30. The contact elements 8 can be placed on the film elements 11 and pressed in between a corresponding film pair 12. By laminating or connecting in an integrally bonded manner the film elements 11 of the film pair 12, the contact elements 8 can then already be sufficiently fixed in the connector body 5.

An undulating or—as shown—zigzag course of the contact elements 8 between the contact portions 9 can further strengthen the fixation of the contact elements 8 between the film elements 11.

Optionally, a layer of adhesive or a curing substance can be applied to the film elements 11 to fill the spaces between the contact elements 8.

It can also be provided to press the contact elements 8 into the film elements 11 in such a way that channels are in turn formed in at least one of the film elements 11 forming a film pair 12 as a result of material displacement. The film elements 11 can preferably be formed here in such a way that sufficient material displacement is enabled and preferably no curvature is formed. If necessary, however, a curvature can also be tolerated or compensated for by further film elements 11 of the stack.

What is claimed is:

1. A multi-way connector for electrically contacting electrical assemblies, comprising:
a) a connector body with a first connection face and with a second connection face;
b) a plurality of electrical contact elements which extend at least from the first connection face to the second connection face through the connector body, wherein the contact elements each form contact portions in the region of the connection faces for making electrical contact with corresponding mating contact elements of the associated assembly, and wherein the contact portions can be fastened mechanically on at least one of the connection faces to the associated mating contact elements; and
wherein the connector body has a plurality of film elements stacked on top of one another and connected to one another, wherein in each case at least two of the film elements form a film pair, and wherein at least one of the contact elements runs between the two film elements stacked on top of one another of at least one of the film pairs.

2. The multi-way connector as claimed in claim 1, wherein the film pair forms for each of the contact elements a corresponding channel through which the contact element extends between the connection faces.

3. The multi-way connector (4) as claimed in claim 2, wherein the channels are formed by impressions of the contact elements in at least one of the film elements of the film pair and/or by grooves in at least one of the film elements of the film pair and/or by recesses in an intermediate film structure arranged between the film elements of the film pair.

4. The multi-way connector as claimed in claim 1, wherein the first connection face and the second connection face are arranged on different sides of the connector body.

5. The multi-way connector as claimed in claim 4, wherein the first connection face and the second connection face are arranged on opposite sides of the connector body.

6. The multi-way connector as claimed in claim 4, wherein the first connection face and the second connection face are arranged on sides of the connector body which are adjacent to one another via a common edge.

7. The multi-way connector (4) as claimed in claim 1, wherein the film elements of the connector body are connected to each other in an integrally bonded manner, at least in some regions.

8. The multi-way connector as claimed in claim 1, wherein in each case exactly two of the film elements of the connector body form one of the film pairs, wherein the contact elements run in each case between the mutually facing main faces of the film elements forming a film pair.

9. The multi-way connector as claimed in claim 1, wherein the contact portions of the contact elements protrude from the particular connection face.

10. The multi-way connector as claimed in claim 1, wherein the contact portions of the contact elements are designed as rounded contact heads, as contact pins, as contact assemblies of a plug connector and/or as soldering faces.

11. The multi-way connector as claimed in claim 1, wherein the contact elements, in particular the contact portions of the contact elements are incompressible along the longitudinal axis of the contact element.

12. The multi-way connector as claimed in claim 1, wherein the contact elements between the two connection faces have a zigzag course or an undulating course.

13. The multi-way connector as claimed in claim 1, wherein an inner portion of the contact elements running between the two contact portions (9);
a) forms an electrical component or comprises an electrical component; and/or
b) is designed to establish an electrical connection to at least one further inner portion of a further contact element.

14. The multi-way connector as claimed in claim 1, wherein:
a) a plurality or all of the contact elements are arranged in a row next to each other in a common film pair; and/or
b) a plurality or all of the contact elements in the connector body are arranged at different height levels and are distributed over a plurality of film pairs for this purpose.

15. The multi-way connector as claimed in claim 1, wherein the contact element and/or the channel are designed to interlockingly secure the contact element in the connector body against withdrawal.

16. The multi-way connector as claimed in claim 1, wherein the contact element is pressed and/or connected in an integrally bonded manner to at least one of the film elements of the film pair.

17. The multi-way connector as claimed in claim 1, wherein the contact portions of the contact elements are arranged in the first connection face according to a first pitch and are arranged in the second connection face according to a second pitch.

18. The multi-way connector as claimed in claim 1, wherein the connector body is fastened to at least one support body or is at least partially accommodated in at least one support body to mechanically stabilize the connector body.

19. The multi-way connector as claimed in claim 1, wherein the connector body is accommodated in an electrically conductive shielding housing to electromagnetically shield the connector body.

20. The multi-way connector as claimed in claim 1, wherein for the electromagnetic shielding of contact elements in the connector body:
a) at least one of the film elements of one of the film pairs has a metal coating on a main face facing away from the contact elements; and/or
b) a metal film or a metal sheet is arranged between at least two film pairs; and/or
c) a shielding element is arranged between at least two of the contact elements of a common film pair.

21. An assembly connection having a first electrical assembly and/or a second electrical assembly as well as a multi-way connector as claimed in claim 1 for electrically contacting the first and second electrical assemblies.

22. A method for producing a multi-way connector which is designed for the electrical contacting of electrical assemblies, according to which a plurality of contact elements are inserted in parallel or sequentially into a connector body of the multi-way connector, said connector body having a plurality of film elements stacked one on top of the other and connected to one another, wherein the contact elements are inserted into the connector body in such a way that respective contact portions of the contact elements are arranged in the region of connection faces of the connector body for the electrical contacting and mechanical fastening of corresponding mating contact elements, and wherein the film elements are connected to one another in an integrally bonded manner, at least in some regions.

23. The method as claimed in claim 22,
wherein the film elements are stacked on top of each other to produce the connector body layer by layer, wherein the contact elements are laid in the channels of the film pairs and/or are pressed together with the film elements during the stacking of the film elements.

24. The method as claimed in claim 23,
wherein the contact elements are inserted into respective channels of film pairs formed from at least two film elements and/or are pressed into at least one film element of the film pair.

25. The method as claimed in claim 22, wherein:
a) a plurality or all of the contact elements are inserted in a row adjacent to each other in a common film pair; and/or
b) multiple film pairs are created to distribute multiple contact elements in the connector body at different height levels.

26. The method as claimed in claim 22, wherein a plurality of contact elements connected via a carrier strip are applied together to a film element.

27. The method as claimed in claim 22, wherein the contact elements are stamped out from a sheet material or are machined out by an etching process.

28. The method as claimed in claim 22, wherein the film elements are connected to one another by ultrasonic welding, laser welding, hot caulking and/or adhesive bonding of the main faces of the film elements.

29. (canceled)
